(19) United States
(12) Patent Application Publication
(10) Pub. No.: US 2023/0037010 A1
(43) Pub. Date: Feb. 2, 2023

(54) CONTROL DEVICE, STORAGE MEDIUM, AND ENERGY MANAGEMENT SYSTEM

(71) Applicant: TOYOTA JIDOSHA KABUSHIKI KAISHA, Toyota-shi (JP)

(72) Inventors: Junichi MORI, Nagakute-shi (JP); Kentaro BAN, Susono-shi (JP); Tatsuro KIYOHARA, Hiratsuka-shi (JP); Yuta MANIWA, Susono-shi (JP); Yuki NISHIKAWA, Sunono-shi (JP)

(21) Appl. No.: 17/805,086

(22) Filed: Jun. 2, 2022

(30) Foreign Application Priority Data
Jul. 27, 2021 (JP) 2021-122673

(51) Int. Cl. G06Q 10/06; G06Q 50/06

(52) U.S. Cl. CPC G06Q 10/06315; G06Q 10/0635; G06Q 50/06

(57) ABSTRACT

A control device according to the present disclosure includes a processor configured to output, when disaster prediction information predicting a disaster is acquired, a control signal for raising at least one of a lower limit value and an upper limit value of stored energy in a supply and demand operation plan of energy before the disaster prediction information is acquired.

### CROSS-REFERENCE TO RELATED APPLICATION

This application claims priority to Japanese Patent Application No. 2021-122673 filed on Jul. 27, 2021, incorporated herein by reference in its entirety.

### BACKGROUND

### 1. Technical Field

The present disclosure relates to a control device, a storage medium, and an energy management system.

### 2. Description of Related Art

Japanese Unexamined Patent Application Publication No. 2013-229992 (JP 2013-229992 A) discloses that a charging process for charging an electric power storage device, an in-vehicle battery, or the like is performed when disaster prediction information is received.

### SUMMARY

When a lower limit value and an upper limit value of stored energy in a supply and demand operation plan during the time before a disaster occurs are not considered, there is a risk that energy stored in an energy storage device is overused or energy is excessively stored in the energy storage device.

The present disclosure has been made in view of the above issue, and an object thereof is to provide a control device, a storage medium, and an energy management system capable of suppressing the overuse of stored energy or excessive storage of energy during the time before a disaster occurs.

A control device according to the present disclosure includes a processor configured to output, when disaster prediction information predicting a disaster is acquired, a control signal for raising at least one of a lower limit value and an upper limit value of stored energy in a supply and demand operation plan of energy before the disaster prediction information is acquired.

A storage medium according to the present disclosure stores a program that causes a processor to execute outputting, when disaster prediction information predicting a disaster is acquired, a control signal for raising at least one of a lower limit value and an upper limit value of stored energy in a supply and demand operation plan of energy before the disaster prediction information is acquired.

An energy management system according to the present disclosure includes a first control device that includes a first processor and an energy storage device that stores energy supplied based on a supply and demand operation plan of the energy, and a second control device that includes a second processor that outputs, when disaster prediction information predicting a disaster is acquired, a control signal for raising at least one of a lower limit value and an upper limit value of stored energy in the supply and demand operation plan of the energy before the disaster prediction information is acquired.

The present disclosure has an effect of suppressing the overuse of stored energy and the excessive storage of energy during the time before the disaster occurs.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram showing a schematic configuration of an electric power management system according to an embodiment;

FIG. 2 is a diagram showing a schematic configuration of a server;

FIG. 3 is a schematic configuration diagram of a facility and a power generation facility;

FIG. 4 is a flowchart showing an example of control to be performed when a server control device acquires weather forecast information;

FIG. 5 is a flowchart showing an example of control to be performed when the server control device acquires earthquake prediction information or earthquake detection information; and

FIG. 6 is a flowchart showing an example of control to be performed when the server control device acquires fire alarm information.

### DETAILED DESCRIPTION OF EMBODIMENTS

Hereinafter, an embodiment of an electric power management system as a control device, a storage medium, and an energy management system according to the present disclosure will be described. Note that, the present embodiment does not limit the present disclosure.

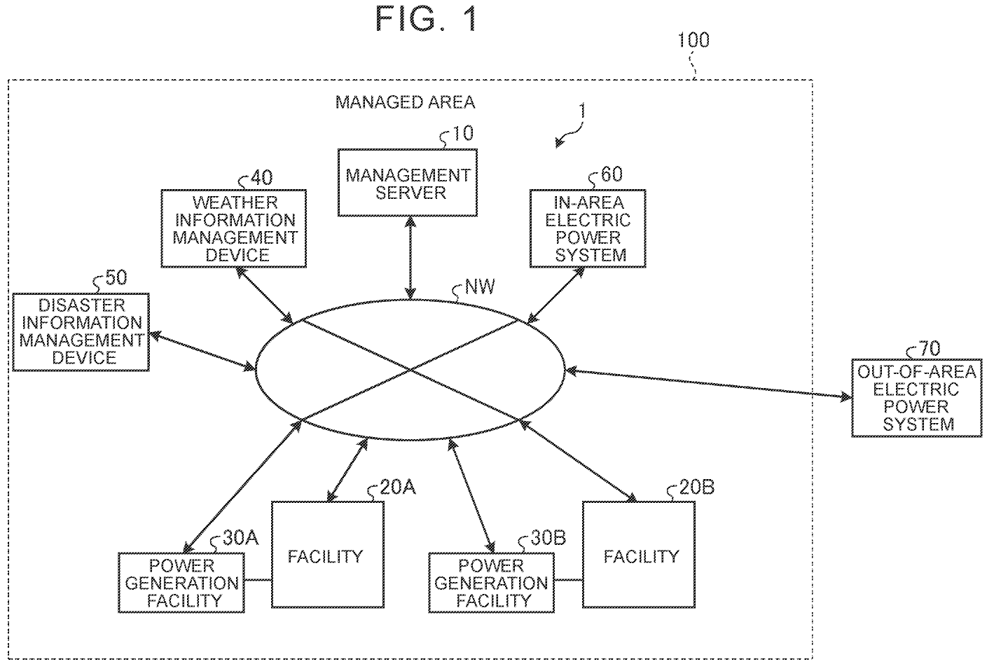

FIG. 1 is a diagram showing a schematic configuration of an electric power management system 1 according to the embodiment. The electric power management system 1 includes a management server 10, a plurality of facilities 20A and 20B, a plurality of power generation facilities 30A and 30B, a weather information management device 40, a disaster information management device 50, an in-area electric power system 60, and a network NW provided in a managed area 100, and an out-of-area electric power system 70 provided outside the managed area 100.

In the following description, when the facilities 20A and 20B are not particularly distinguished, they are simply referred to as a facility 20. The facility 20 includes, for example, residential, commercial, and public facilities. Further, when the power generation facilities 30A and 30B are not particularly distinguished, they are simply referred to as a power generation facility 30. In FIG. 1, for convenience of explanation, only the two facilities 20A and 20B and the two power generation facilities 30A and 30B are shown, but the number of the facilities 20 and the number of the power generation facilities 30 provided in the managed area 100 are not particularly limited to two. Further, each of the in-area electric power system 60 and the out-of-area electric power system 70 is, for example, a power plant provided by an electricity business operator and an electric power network composed of a power transmission and distribution facility.

The electric power management system 1 manages, for example, supply of electric power from the power generation facility 30, the in-area electric power system 60, and the out-of-area electric power system 70 to the facility 20 by the management server 10 based on a supply and demand operation plan for balancing supply and demand of the electric power in the managed area 100.

The management server 10 is configured such that the facilities 20A and 20B, the power generation facilities 30A and 30B, the weather information management device 40, the disaster information management device 50, the in-area electric power system 60, and the out-of-area electric power system 70 can communicate with each other via the network NW.

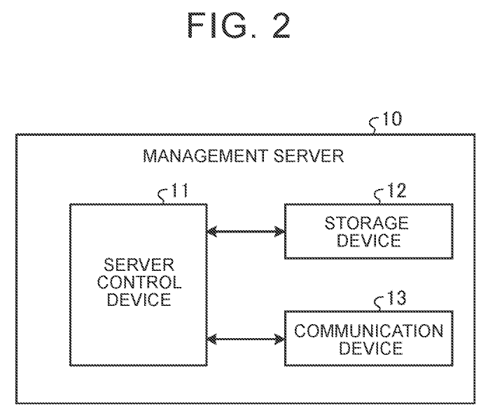

FIG. 2 is a diagram showing a schematic configuration of the management server 10. The management server 10 includes a server control device 11, a storage device 12, and a communication device 13.

The server control device 11 is provided with a processor including a central processing unit (CPU), a digital signal processor (DSP), a field-programmable gate array (FPGA), etc., and a memory including a random access memory (RAM), a read-only memory (ROM), etc. The server control device 11 loads a program stored in the storage device 12 into the work area of the memory and executes the program, and controls each component, etc. through the execution of the program such that the function that satisfies a predetermined purpose can be realized.

The storage device 12 is configured of a recording medium (a storage medium) such as an erasable programmable ROM (EPROM), a hard disk drive (HDD), and a removable media. Examples of the removable medium include disk recording media such as an optical disc (e.g. compact disc (CD)-R or CD-ROM, digital versatile disc (DVD)-R or DVD-ROM, Blu-ray (registered trademark) disc) and a flash memory (a universal serial bus (USB) memory or a memory card). The storage device 12 can store an operating system (OS), various programs, various tables, various databases, and the like, and, for example, stores the supply and demand operation plan for balancing supply and demand of electric power in the managed area 100. Further, the storage device 12 stores a facility identification (ID) that is unique information for identifying each of the facilities 20A and 20B, and a power generation facility ID that is unique information for identifying each of the power generation facilities 30A and 30B.

The communication device 13 is composed of, for example, a local area network (LAN) interface board, a wireless communication circuit for wireless communication, and the like. The communication device 13 is connected to the network NW such as the Internet that is a public communication network. Then, the communication device 13 realizes bidirectional communication between the server control device 11 and the network NW by connecting to the network NW.

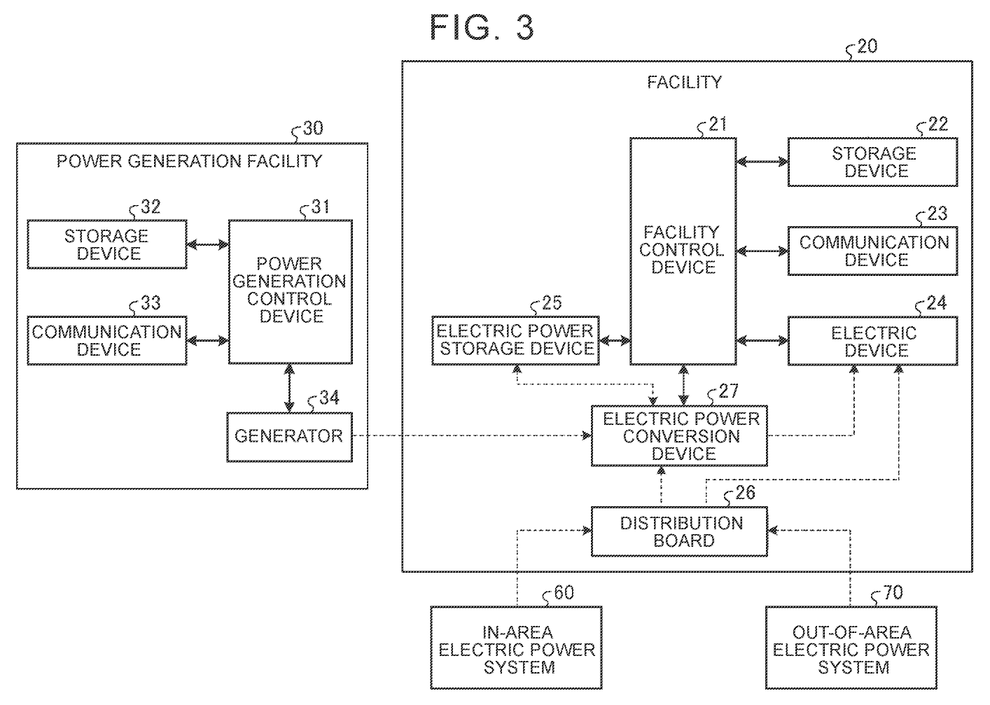

FIG. 3 is a schematic configuration diagram of the facility 20 and the power generation facility 30.

The facility 20 is provided with a facility control device 21, a storage device 22, a communication device 23, an electric device 24, an electric power storage device 25, a distribution board 26, an electric power conversion device 27, and the like. The physical configurations of the facility control device 21, the storage device 22, and the communication device 23 are the same as, for example, the configurations of the server control device 11, the storage device 12, and the communication device 13 included in the management server 10, respectively.

The electric device 24 is a lighting or a home electric appliance provided in the facility 20.

The electric power storage device 25 includes a secondary battery such as a lithium ion battery or a nickel hydrogen battery, for example. Note that, as the electric power storage device 25, a capacitor such as an electric double layer capacitor can also be adopted. The electric power storage device 25 can store electric power supplied from the in-area electric power system 60, the out-of-area electric power system 70, and the power generation facility 30A, or discharge the electric power to the electric device 24.

The distribution board 26 divides the electric power from the in-area electric power system 60 and the out-of-area electric power system 70 into the electric device 24, the electric power conversion device 27, and the like.

The electric power conversion device 27 converts electric power supplied from the in-area electric power system 60 and the out-of-area electric power system 70 to the electric power storage device 25 via the distribution board 26, electric power supplied from a generator 34 of the power generation facility 30 via the distribution board 26, and electric power supplied from the electric power storage device 25 to the electric device 24 as appropriate according to a command from the facility control device 21.

The power generation facility 30 is a facility for generating electric power for using the electric device 24 provided in the facility 20, electric power for charging the electric power storage device 25 provided in the facility 20, and the like. The power generation facility 30 is provided with a power generation control device 31, a storage device 32, a communication device 33, the generator 34, and the like. The physical configurations of the power generation control device 31, the storage device 32, and the communication device 33 are the same as, for example, the configurations of the server control device 11, the storage device 12, and the communication device 13 included in the management server 10, respectively.

The generator 34 is composed of, for example, a fuel cell that generates electricity using hydrogen supplied from a hydrogen supply source. Note that, the generator 34 may have a configuration in which electricity is generated with a rotary electric machine by operating an internal combustion engine using liquid fuel such as petroleum fuel or alcohol. The electric power generated by the generator 34 is supplied to the electric power conversion device 27 of the facility 20 via an electric power cable or the like. Then, the electric power supplied to the electric power conversion device 27 is transformed and supplied to the electric device 24, or is transformed from alternating current to direct current and supplied to the electric power storage device 25 to charge the electric power storage device 25.

The facility control device 21 can perform, for example, control for adjusting electric energy supplied from the in-area electric power system 60, the out-of-area electric power system 70, and the generator 34 to the electric power storage device 25 via the electric power conversion device 27 such that stage of charge (SOC) of the electric power storage device 25 falls between the lower limit value and the upper limit value set in advance as initial values. In the electric power management system 1 according to the embodiment, the initial values of the lower limit value and the upper limit value of the SOC of the electric power storage device 25 are 20[%] in the lower limit value and 80 [%] in the upper limit value when the SOC in a fully charged state is 100 [%].

Here, in the electric power management system 1 according to the embodiment, the upper limit value of the SOC of the electric power storage device 25 is not set to 100 [%] because the lithium ion battery is deteriorated at an early stage when the lithium ion battery constituting the electric power storage device 25 is repeatedly fully charged such that the SOC is 100 [%]. When the electric power storage device 25 is composed of a secondary battery other than the lithium ion battery and there is no risk of deterioration at an early stage even after the secondary battery is repeatedly fully charged, the upper limit value of the SOC of the electric power storage device 25 can be set to 100 [%].

Returning to FIG. 1, the weather information management device 40 is, for example, a device that outputs weather information related to the managed area 100 to the management server 10 via the network NW. The weather information management device 40 acquires the weather information from, for example, public or private organizations that issue weather forecasts.

The disaster information management device 50 is, for example, a device that outputs disaster information related to the managed area 100 to the management server 10 via the network NW. The disaster information management device 50 acquires information related to disasters such as heavy rains, floods, typhoons, and earthquakes from the public or private organizations that issue weather forecasts, disaster prevention centers of national and local governments, etc. (hereinafter also referred to as disaster information). Note that, the disaster information also includes the predicted time of occurrence of a disaster predicted in the future.

Here, when disasters such as heavy rains, lightning strikes, earthquakes, and fires occur in the managed area 100, it may be difficult to supply electric power from the in-area electric power system 60 to each facility 20 due to a power outage or the like, or the usage amount of electric power may become much larger than in normal times. In this case, in each facility 20, the electric power stored in the electric power storage device 25 is mainly used for the electric device 24, but when the electric power of the electric power storage device 25 is overused during the time before the disaster occurs, there is a risk that the electric energy in the electric power storage device 25 that can be used in the event of a disaster is insufficient.

Therefore, in the electric power management system 1 according to the embodiment, when a disaster is predicted to occur in the managed area 100, it is possible to perform electric power management control for raising the lower limit value and the upper limit value of the SOC of the electric power storage device 25 provided in each facility 20 as compared with the initial values.

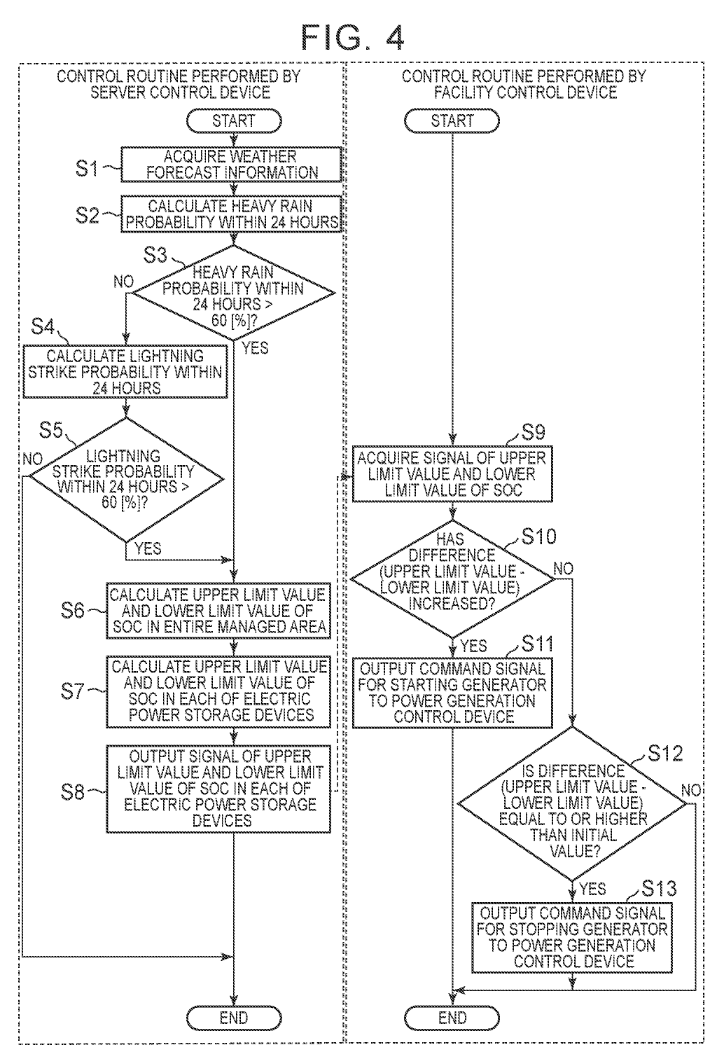

FIG. 4 is a diagram showing an electric power management control routine to be performed when the server control device 11 acquires weather forecast information in the electric power management system 1. The electric power management control routine shown in FIG. 4 is performed in cooperation with the server control device 11 and the facility control device 21, and is composed of a control routine executed by the server control device 11 and a control routine executed by the facility control device 21.

First, the server control device 11 acquires the weather forecast information from the weather information management device 40 via the network NW or the like (step S1). Next, the server control device 11 calculates the heavy rain probability within 24 hours in the managed area 100 based on the weather forecast information (step S2). Next, the server control device 11 determines whether a relationship of the heavy rain probability within 24 hours > 60 [%] is satisfied based on the calculated heavy rain probability within 24 hours (step S3). The criterion value for determining the heavy rain probability within 24 hours is not limited to 60 [%]. When the server control device 11 determines that the relationship of the heavy rain probability > 60 [%] within 24 hours is satisfied (Yes in step S3), the process proceeds to step S6.

On the other hand, when the server control device 11 determines in step S3 that the relationship of the heavy rain probability > 60 [%] within 24 hours is not satisfied (No in step S3), the server control device 11 calculates the lightning strike probability within 24 hours in the managed area 100 (step S4). The criterion value for determining the lightning strike probability within 24 hours is not limited to 60 [%]. Next, the server control device 11 determines whether the relationship of the lightning strike probability > 60 [%] within 24 hours is satisfied (step S5). When the server control device 11 determines that the relationship of the lightning strike probability> 60 [%] within 24 hours is not satisfied (No in step S5), the server control device 11 ends this control routine. On the other hand, when the server control device 11 determines in step S5 that the relationship of the lightning strike probability > 60 [%] within 24 hours is satisfied (Yes in step S5), the process proceeds to step S6.

Next, the server control device 11 calculates the lower limit value and the upper limit value of the SOC in the supply and demand operation plan, in other words, the lower limit value and the upper limit value of the SOC in the entire managed area 100 (the total SOC obtained by adding the SOC of all the electric power storage devices 25 provided in the managed area 100) (step S6). For example, when the initial value of the lower limit value of the SOC in the supply and demand operation plan (entire managed area 100) is 20 [%], ((20 + 50 × max) ÷ 100) [%] is calculated as the lower limit value of the SOC in the supply and demand operation plan (entire managed area 100). In the formula, “max” is the heavy rain probability or the lightning strike probability [%] within 24 hours. Further, for example, when the initial value of the upper limit value of the SOC in the supply and demand operation plan (entire managed area 100) is 80 [%], the upper limit value of the SOC in the supply and demand operation plan (entire managed area 100) is calculated as 90 [%].

Next, the server control device 11 calculates the upper limit value and the lower limit value of the SOC of each of the electric power storage devices 25 in order to distribute the SOC in the entire managed area 100 to each of the electric power storage devices 25 provided in each of the facilities 20 (step S7). Next, the server control device 11 outputs the signal of the upper limit value and the lower limit value of the SOC of each of the electric power storage devices 25 to each of the facility control devices 21 that controls each of the electric power storage devices 25 via the network NW (step S8). Then, the server control device 11 ends this control routine.

Next, the facility control device 21 acquires the signal of the upper limit value and the lower limit value of the SOC in the electric power storage device 25 from the server control device 11 via the network NW or the like (step S9). Next, the facility control device 21 determines whether a difference (upper limit value - lower limit value) between the upper limit value and the lower limit value of the SOC in the electric power storage device 25 has increased (step S10). When the facility control device 21 determines that the difference (upper limit value - lower limit value) between the upper limit value and the lower limit value of the SOC in the electric power storage device 25 has increased (Yes in step S10), the facility control device 21 outputs a command signal for starting the generator 34 to the power generation control device 31 (step S11). Then, the facility control device 21 ends this control routine.

On the other hand, when the facility control device 21 determines in step S10 that the difference (upper limit value - lower limit value) between the upper limit value and the lower limit value of the SOC in the electric power storage device 25 has not increased (No in step S10), the facility control device 21 determines whether the difference (upper limit value - lower limit value) between the upper limit value and the lower limit value of the SOC in the electric power storage device 25 is equal to or higher than the preset initial value (step S12). When the facility control device 21 determines that the difference (upper limit value -lower limit value) between the upper limit value and the lower limit value of the SOC in the electric power storage device 25 is not equal to or higher than the initial value (No in step S12), the facility control device 21 ends this control routine. When the facility control device 21 determines in step S12 that the difference (upper limit value - lower limit value) between the upper limit value and the lower limit value of the SOC in the electric power storage device 25 is equal to or higher than the initial value (Yes in step S12), the facility control device 21 outputs a command signal for stopping the generator 34 to the power generation control device 31 (step S13). Then, the facility control device 21 ends this control routine.

As a result, in the electric power management system 1 according to the embodiment, when the management server 10 acquires disaster prediction information that is weather forecast information including the occurrence probability that the heavy rain or the lightning strike occur with a probability of 60 [%] or more within 24 hours, in other words, when a disaster is predicted, the upper limit value and the lower limit value of the SOC in the supply and demand operation plan (entire managed area 100) are changed to be raised as compared with the state before the disaster prediction information is acquired (before the disaster is predicted), and based on this change in the supply and demand operation plan, the upper limit value and the lower limit value of the SOC in each of the electric power storage devices 25 are raised as compared with the state before the disaster prediction information is acquired (before the disaster is predicted). As a result, it is possible to suppress the electric power stored in each of the electric power storage devices 25 from being overused or the electric power from being excessively stored in each of the electric power storage devices 25 by charging during the time before the predicted disaster occurs.

In addition, according to the disaster occurrence probability included in the disaster prediction information, for example, the heavy rain probability within 24 hours or the lightning strike probability within 24 hours, a raising amount of at least one of the upper limit value and the lower limit value of the SOC in the supply and demand operation plan (electric power storage device 25) may be changed. As a result, the electric energy stored in the electric power storage device 25 can be appropriately set according to the disaster occurrence probability (heavy rain probability within 24 hours, lightning strike probability within 24 hours, and the like).

Further, in the electric power management system 1 according to the embodiment, when the predicted disaster is an earthquake or a fire, the raising amount of at least one of the upper limit value and the lower limit value of the SOC in the supply and demand operation plan (electric power storage device 25) may be maximized.

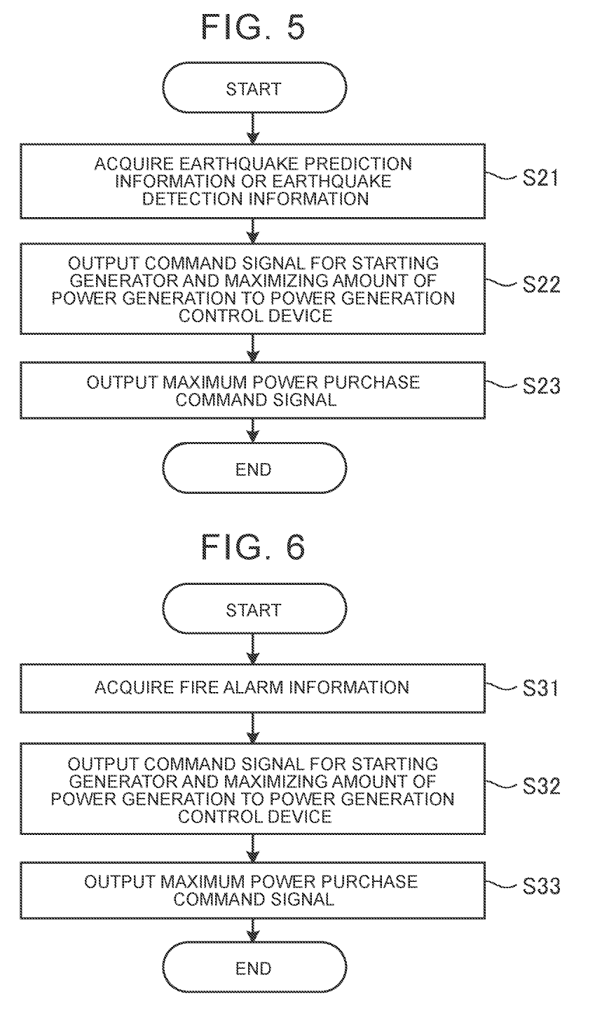

FIG. 5 is a flowchart showing an example of control to be performed when the server control device 11 acquires earthquake prediction information or earthquake detection information.

First, the server control device 11 acquires earthquake prediction information or earthquake detection information (step S21). Next, the server control device 11 outputs a command signal for starting the generator 34 and maximizing the amount of power generation to the power generation control device 31 via the network NW or the like (step S22). Next, the server control device 11 outputs, to the facility control device 21, a maximum power purchase command signal for setting the electric energy (power purchase amount) purchased from the out-of-area electric power system 70 to the preset maximum value via the network NW or the like (step S23). Then, the server control device 11 ends this control routine.

As a result, in the electric power management system 1 according to the embodiment, as much electric power as possible is supplied from the generator 34 and the out-of-area electric power system 70 to the electric power storage device 25 and is stored therein, enabling preparation for electric power demand against an earthquake that requires urgent measures as compared with other disasters.

FIG. 6 is a flowchart showing an example of control to be performed when the server control device 11 acquires fire alarm information.

First, the server control device 11 acquires fire alarm information (step S31). Next, the server control device 11 outputs a command signal for starting the generator 34 and maximizing the amount of power generation to the power generation control device 31 via the network NW or the like (step S32). Next, the server control device 11 outputs, to the facility control device 21, a maximum power purchase command signal for setting the electric energy (power purchase amount) purchased from the out-of-area electric power system 70 to the preset maximum value via the network NW or the like (step S33). Then, the server control device 11 ends this control routine.

As a result, in the electric power management system 1 according to the embodiment, as much electric power as possible is supplied from the generator 34 and the out-of-area electric power system 70 to the electric power storage device 25 and is stored therein, enabling preparation for electric power demand against a fire that requires urgent measures as compared with other disasters.

Further effects and modifications can be easily derived by those skilled in the art. The broader aspects of the present disclosure are not limited to the particular details and representative embodiments shown and described above. Accordingly, various modifications may be made without departing from the spirit or scope of the general inventive concept as defined by the appended claims and their equivalents. For example, the energy to be stored may be not limited to the electric power but hydrogen, and the energy storage device may be provided with a hydrogen storage device for storing hydrogen instead of the electric power storage device 25. Then, for example, when a disaster is predicted, at least one of the upper limit value and the lower limit value of the hydrogen storage amount in the hydrogen storage device may be raised as compared with the state before the disaster is predicted.

What is claimed is:

1. A control device comprising a processor configured to output, when disaster prediction information predicting a disaster is acquired, a control signal for raising at least one of a lower limit value and an upper limit value of stored energy in a supply and demand operation plan of energy before the disaster prediction information is acquired.

2. The control device according to claim 1, wherein the processor changes a raising amount of at least one of the lower limit value and the upper limit value according to occurrence probability included in the disaster prediction information.

3. The control device according to claim 1, wherein the processor outputs a control signal for maximizing a raising amount of at least one of the lower limit value and the upper limit value when the disaster is an earthquake or a fire.

4. The control device according to claim 3, wherein:
the energy is electric power; and
the processor outputs a command signal for starting a generator that generates the electric power to be supplied to an energy storage device when the disaster is the earthquake or the fire.

5. The control device according to claim 4, wherein the processor outputs a command signal for maximizing an amount of power generated by the generator.

6. The control device according to claim 4, wherein the processor outputs a maximum power purchase command signal for setting electric power purchased from an electric power system to a preset maximum amount.

7. A non-transitory storage medium storing a program that causes a processor to execute outputting, when disaster prediction information predicting a disaster is acquired, a control signal for raising at least one of a lower limit value and an upper limit value of stored energy in a supply and demand operation plan of energy before the disaster prediction information is acquired.

8. The storage medium according to claim 7, causing the processor to execute changing a raising amount of at least one of the lower limit value and the upper limit value according to occurrence probability included in the disaster prediction information.

9. The storage medium according to claim 7, causing the processor to execute outputting a control signal for maximizing a raising amount of at least one of the lower limit value and the upper limit value when the disaster is an earthquake or a fire.

10. The storage medium according to claim 9, wherein:
the energy is electric power; and
the program causes the processor to execute outputting a command signal for starting a generator that generates the electric power to be supplied to an energy storage device when the disaster is the earthquake or the fire.

11. The storage medium according to claim 10, causing the processor to execute outputting a command signal for maximizing an amount of power generated by the generator.

12. The storage medium according to claim 9, causing the processor to execute outputting a maximum power purchase command signal for setting electric power purchased from an electric power system to a preset maximum amount.

13. An energy management system comprising:
a first control device that includes a first processor and an energy storage device that stores energy supplied based on a supply and demand operation plan of the energy; and
a second control device that includes a second processor that outputs, when disaster prediction information predicting a disaster is acquired, a control signal for raising at least one of a lower limit value and an upper limit value of stored energy in the supply and demand operation plan of the energy before the disaster prediction information is acquired.

14. The energy management system according to claim 13, wherein the second processor changes a raising amount of at least one of the lower limit value and the upper limit value according to occurrence probability included in the disaster prediction information.

15. The energy management system according to claim 13, wherein the first processor outputs a command signal for starting a generator that generates electric power to be supplied to the energy storage device when a difference between the upper limit value and the lower limit value is increased as compared with a state before at least one of the upper limit value and the lower limit value is raised.

16. The energy management system according to claim 13, wherein the first processor outputs a command signal for stopping a generator that generates electric power to be supplied to the energy storage device when a difference between the upper limit value and the lower limit value is equal to or higher than a preset initial value.

17. The energy management system according to claim 13, wherein the second processor outputs a control signal for maximizing a raising amount of at least one of the lower limit value and the upper limit value when the disaster is an earthquake or a fire.

18. The energy management system according to claim 17, wherein:
the energy is electric power; and
the second processor outputs a command signal for starting a generator that generates the electric power to be supplied to the energy storage device.

19. The energy management system according to claim 18, wherein the second processor outputs a command signal for maximizing an amount of power generated by the generator.

20. The energy management system according to claim 17, wherein the second processor outputs a maximum power purchase command signal for setting electric power purchased from an electric power system to a preset maximum amount.
